(19) United States
(12) Patent Application Publication
(10) Pub. No.: US 2025/0313739 A1
(43) Pub. Date: Oct. 9, 2025

(54) END-USE APPLICATIONS FOR LOW VISCOSITY AND HIGH FLASH POINT PAO SOLVENTS

(71) Applicant: Chevron Phillips Chemical Company LP, The Woodlands, TX (US)

(72) Inventors: Spencer A. Kerns, Kingwood, TX (US); Thomas J. Malinski, The Woodlands, TX (US); Eric P. Weber, Kingwood, TX (US); Steven M. Bischof, Kingwood, TX (US); Kenneth D. Hope, The Woodlands, TX (US)

(21) Appl. No.: 19/171,467

(22) Filed: Apr. 7, 2025

Related U.S. Application Data
(60) Provisional application No. 63/631,542, filed on Apr. 9, 2024.
(60) Provisional application No. 63/631,550, filed on Apr. 9, 2024.

(51) Int. Cl. C09K 5/10; B60L 58/26; H01M 10/48; H01M 10/613; H01M 10/625; H01M 10/63; H01M 10/6567

(52) U.S. Cl. CPC C09K 5/10; H01M 10/48; H01M 10/613; H01M 10/625; H01M 10/63; H01M 10/6567; B60L 58/26; H01M 2220/20

(57) ABSTRACT

A non-pyrophoric composition contains a pyrophoric material and an alkane composition that comprises C₁₆-C₃₆ alkanes. A battery temperature control system contains a battery assembly in direct contact with an alkane composition comprising C₁₆-C₃₆ alkanes, the alkane composition contained within an outer casing, an inlet for introducing the alkane composition to the battery assembly, and an outlet for discharging the alkane composition from the battery assembly. Another battery system contains an internal battery assembly, a separator film encapsulating the internal battery assembly, an outer shell surrounding the separator film and the internal battery assembly, and a liquid layer containing an alkane composition that comprises C₁₆-C₃₆ alkanes. The liquid layer is positioned between the outer shell and the separator film.

### REFERENCE TO RELATED APPLICATIONS

This application claims the benefit of U.S. Provisional Patent Application Nos. 63/631,542 and 63/631,550, filed on Apr. 9, 2024, the disclosures of which are incorporated herein by reference in their entirety.

### FIELD OF THE INVENTION

The present disclosure relates to uses of C₁₆ alkane compositions, C₂₄ alkane compositions, and mixed C₁₆-C₂₄ alkane compositions as solvents for pyrophoric materials and as protective and thermal control fluids for battery applications.

### BACKGROUND OF THE INVENTION

Alkanes of various carbon numbers are used as low viscosity solvents in a multitude of applications. However, low flash points and volatility and flammability concerns limit the utility of certain alkanes. Thus, it would be beneficial to develop alkane compositions with both low viscosity and high flash points in order to improve their performance in current end-use applications and to utilize the alkane compositions in new end-use applications. Accordingly, it is to these ends that the present invention is generally directed.

### SUMMARY OF THE INVENTION

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

In an aspect, non-pyrophoric compositions are described herein and these compositions can comprise an alkane composition comprising C₁₆-C₃₆ alkanes and a pyrophoric material. The pyrophoric material can be an organometallic (such as an organoaluminum, an organolithium, or an organoboron), or a reactive metal (such as sodium, potassium, or lithium), although not limited thereto.

In another aspect, a battery temperature control system is provided, and in this aspect, the system can comprise (i) a battery assembly in direct contact with (and surrounded by) an alkane composition comprising C₁₆-C₃₆ alkanes, the alkane composition contained within an outer casing, (ii) an inlet for introducing the alkane composition to the battery assembly, and (iii) an outlet for discharging the alkane composition from the battery assembly.

In yet another aspect, a battery system is provided, and in this aspect, the system can comprise (I) an internal battery assembly, (II) a separator film encapsulating the internal battery assembly, (III) an outer shell (or casing) surrounding the separator film and the internal battery assembly, and (IV) a liquid layer comprising an alkane composition comprising C₁₆-C₃₆ alkanes, the liquid layer positioned between the outer shell and the separator film.

The alkane composition comprising C₁₆-C₃₆ alkanes often can be one of three alkane compositions disclosed herein: a first alkane composition comprising at least 90 wt. % C₁₆ alkanes (hydrogenated 1-octene dimers), a second alkane composition comprising at least 90 wt. % C₂₄ alkanes (hydrogenated 1-octene trimers), or a third alkane composition comprising from 5 to 95 wt. % C₁₆ alkanes (hydrogenated 1-octene dimers) and (b) from 95 to 5 wt. % C₂₄ alkanes (hydrogenated 1-octene trimers), based on a total weight of the C₁₆ alkanes and the C₂₄ alkanes.

Methods of controlling or moderating battery temperature are disclosed herein, and these methods can comprise (a) introducing an alkane composition into an inlet of a battery temperature control system, the battery temperature control system comprising an outer casing encompassing the alkane composition and a battery assembly, wherein the alkane composition comprises C₁₆-C₃₆ alkanes, (b) directly contacting the alkane composition with the battery assembly to regulate a temperature of the battery assembly, and (c) discharging the alkane composition from the battery assembly through an outlet of the battery temperature control system.

In another aspect, methods of temperature control of a battery system are provided, and in this aspect, the methods can comprise (a) providing a battery system comprising (I) an internal battery assembly, (II) a separator film encapsulating the internal battery assembly, (III) and an outer shell surrounding the separator film and the internal battery assembly, and (b) positioning a liquid layer between the outer shell and the separator film to regulate temperature, wherein the liquid layer comprises an alkane composition comprising C₁₆-C₃₆ alkanes.

Both the foregoing summary and the following detailed description provide examples and are explanatory only. Accordingly, the foregoing summary and the following detailed description should not be considered to be restrictive. Further, features or variations can be provided in addition to those set forth herein. For example, certain aspects and embodiments can be directed to various feature combinations and sub-combinations described in the detailed description.

### BRIEF DESCRIPTION OF THE FIGURES

The following figures form part of the present specification and are included to further demonstrate certain aspects of the present invention. The invention may be better understood by reference to these figures in combination with the detailed description.

FIG. 1 illustrates a schematic diagram of a battery temperature control system consistent with an aspect of this invention.

FIG. 2 illustrates a schematic diagram of a battery system containing a battery cell consistent with another aspect of this invention.

FIG. 3 illustrates a schematic diagram of a battery system containing a battery pack consistent with yet another aspect of this invention.

While the inventions disclosed herein are susceptible to various modifications and alternative forms, only a few specific aspects have been shown by way of example in the drawings and described in detail below. The figures and detailed description of specific aspects are not intended to limit the breadth or scope of the inventive concepts or the appended claims in any manner. Rather, the figures and detailed description are provided to illustrate the inventive concepts to a person of ordinary skill in the art and to enable such person to make and use the inventive concepts.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter can be described such that, within particular aspects, a combination of different features can be envisioned. For each and every aspect and/or feature disclosed herein, all combinations that do not detrimentally affect the compositions, systems, and processes/methods described herein are contemplated with or without explicit description of the particular combination. Additionally, unless explicitly recited otherwise, any aspect and/or feature disclosed herein can be combined to describe inventive compositions, systems, and processes/methods consistent with the present disclosure.

In this disclosure, while compositions, systems, and processes/methods are described in terms of “comprising” various components, parts, or steps, the compositions, systems, and processes/methods also can “consist essentially of” or “consist of” the various components, parts, or steps, unless stated otherwise. The terms “a,” “an,” and “the” are intended to include plural alternatives, e.g., at least one, unless otherwise specified. For instance, the disclosure of “an additive” is meant to encompass one additive, or combinations of two or more additives, unless otherwise specified.

Generally, groups of elements are indicated using the numbering scheme indicated in the version of the periodic table of elements published in Chemical and Engineering News, 63(5), 27, 1985. In some instances, a group of elements can be indicated using a common name assigned to the group; for example, alkali metals for Group 1 elements, alkaline earth metals for Group 2 elements, transition metals for Group 3-12 elements, and halogens or halides for Group 17 elements.

For any particular compound or group disclosed herein, any name or structure (general or specific) presented is intended to encompass all conformational isomers, regioisomers, stereoisomers, and mixtures thereof that can arise from a particular set of substituents, unless otherwise specified. The name or structure (general or specific) also encompasses all enantiomers, diastereomers, and other optical isomers (if there are any) whether in enantiomeric or racemic forms, as well as mixtures of stereoisomers, as would be recognized by a skilled artisan, unless otherwise specified. For instance, a general reference to pentane includes n-pentane, 2-methyl-butane, and 2,2-dimethylpropane; and a general reference to a butyl group includes a n-butyl group, a sec-butyl group, an iso-butyl group, and a t-butyl group.

The terms “contacting” and “combining” and the like are used herein to describe compositions, systems, and processes/methods in which the materials or components are contacted or combined together in any order, in any manner, and for any length of time, unless otherwise specified. For example, the materials or components can be blended, mixed, slurried, dissolved, reacted, treated, impregnated, compounded, or otherwise contacted or combined in some other manner or by any suitable method or technique.

The term “hydrocarbon” refers to a compound containing only carbon and hydrogen. Other identifiers can be utilized to indicate the presence of particular groups in the hydrocarbon (e.g., halogenated hydrocarbon indicates that the presence of one or more halogen atoms replacing an equivalent number of hydrogen atoms in the hydrocarbon).

The term “alkane” refers to a saturated hydrocarbon compound. The alkane can be linear, branched, or cyclic. Therefore, alkane compositions can include linear alkanes, or branched alkanes, or cyclic alkanes, or mixtures or combinations of linear alkanes, branched alkanes, and cyclic alkanes.

The term “olefin” refers to hydrocarbons that have at least one carbon-carbon double bond that is not part of an aromatic ring or an aromatic ring system. The term “olefin” includes aliphatic and aromatic, cyclic and acyclic, and/or linear and branched hydrocarbons having at least one carbon-carbon double bond that is not part of an aromatic ring or ring system unless specifically stated otherwise. Olefins having only one, only two, only three, etc., carbon-carbon double bonds can be identified by use of the term “mono,” “di,” “tri,” etc., within the name of the olefin. The olefins can be further identified by the position of the carbon-carbon double bond(s).

The term “alpha olefin” refers to any olefin that has a carbon-carbon double bond between the first and second carbon atom of the longest contiguous chain of carbon atoms. The term “alpha olefin” includes linear and branched alpha olefins and alpha olefins which can have more than one non-aromatic carbon-carbon double bond, unless expressly stated otherwise. The term “normal alpha olefin” refers to a linear aliphatic hydrocarbon mono-olefin having a carbon-carbon double bond between the first and second carbon atoms. The term “linear internal olefin” refers to a linear aliphatic hydrocarbon mono-olefin having a double bond that is not between the first and second carbon atom.

The term oligomer refers to a product that contains from 2 to 20 monomer units. The terms “oligomerization product” and “oligomer product” include all products made by the “oligomerization” process, including the “oligomers” and products which are not “oligomers” (e.g., products which contain more than 20 monomer units, or solid polymer), but exclude other non-oligomer components of an oligomerization reactor effluent stream, such as unreacted monomer, organic reaction medium, and hydrogen, amongst other components. The oligomer product generally refers to a composition prior to hydrogenation. These terms also can be used generically herein to include homo-oligomers, co-oligomers, and so forth.

A “polyalphaolefin” (PAO) is a mixture of hydrogenated (or alternatively, substantially saturated) oligomers, containing units derived from an alpha olefin monomer. Unless specified otherwise, the PAO can contain units derived from alpha olefin monomer units, which can be the same (hydrogenated or substantially saturated alpha olefin homo-oligomer) or can be different (hydrogenated or substantially saturated alpha olefin co-oligomer). Generally, the alpha olefin monomer utilized to produce the polyalphaolefin can be any alpha olefin monomer described herein. One having ordinary skill in the art would recognize that the processes for producing the PAO can leave some hydrogenated monomer in the PAO (e.g., less than 1 wt. % based on the total amount of the PAO), and this quantity of hydrogenated monomer can be specified.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. For example, when a chemical moiety having a certain number of carbon atoms is disclosed or claimed, the intent is to disclose or claim individually every possible number that such a range could encompass, consistent with the disclosure herein. For example, the disclosure that a compound is a C₁₆ to C₃₂ alkane, or in alternative language, an alkane having from 16 to 32 carbon atoms, as used herein, refers to a compound that can have 16, 17, 18, 19, 20, 21, 22, 23, 24, 25, 26, 27, 28, 29, 30, 31, or 32 carbon atoms, as well as any range between these two numbers (for example, a C₁₆ to C₂₄ alkane), and also including any combination of ranges between these two numbers (for example, a C₁₆ to C₁₈ and a C₂₈ to C₃₂ alkane).

Similarly, another representative example follows for the 40° C. kinematic viscosity (KV40) of a C₁₆ alkane composition consistent with aspects of this invention. By a disclosure that KV40 is in a range from 2 to 3.6 cSt, the intent is to recite that KV40 can be any value in the range and, for example, can include any range or combination of ranges from 2 to 3.6 cSt, such as from 2 to 3.4 cSt, from 2.2 to 3.6 cSt, from 2.2 to 3.4 cSt, from 2.4 to 3.4 cSt, from 2.4 to 3.2 cSt, from 2.4 to 3 cSt, from 2.6 to 3.2 cSt, from 2.6 to 3 cSt, or from 2.7 to 2.9 cSt, and so forth. Likewise, all other ranges disclosed herein should be interpreted in a manner similar to these examples.

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

Although any methods, devices, and materials similar or equivalent to those described herein can be used in the practice or testing of the invention, the typical methods, devices, and materials are herein described.

All publications and patents mentioned herein are incorporated herein by reference in their entirety for the purpose of describing and disclosing, for example, the constructs and methodologies that are described in the publications and patents, which might be used in connection with the presently described invention.

### DETAILED DESCRIPTION OF THE INVENTION

C₁₆ alkane compositions, C₂₄ alkane compositions, and mixed C₁₆-C₂₄ alkane compositions are disclosed herein. In addition to unexpected combinations of pour point and flash point properties, which are discussed further below, the disclosed alkane compositions have a high degree of saturation, high oxidative stability and chemical inertness, high heat capacity, low electrical conductivity, and low density (low specific gravity). Thus, these alkane compositions are well suited for use as solvents or carriers for pyrophoric materials and as protective and thermal control fluids for battery applications.

### Non-Pyrophoric Compositions

Non-pyrophoric compositions consistent with aspects of this invention can comprise an alkane composition comprising C₁₆-C₃₆ alkanes (or C₁₆-C₃₂ alkanes) and a pyrophoric material. The alkane composition comprising C₁₆-C₃₂ alkanes typically can be one of three alkane compositions disclosed in greater detail herein: a first alkane composition comprising at least 90 wt. % C₁₆ alkanes (hydrogenated 1-octene dimers), a second alkane composition comprising at least 90 wt. % C₂₄ alkanes (hydrogenated 1-octene trimers), or a third alkane composition comprising from 5 to 95 wt. % C₁₆ alkanes (hydrogenated 1-octene dimers) and (b) from 95 to 5 wt. % C₂₄ alkanes (hydrogenated 1-octene trimers), based on a total weight of the C₁₆ alkanes and the C₂₄ alkanes.

A pyrophoric material is generally a compound or metal that rapidly reacts or ignites when exposed to water or oxygen (air). In one aspect, the pyrophoric material can comprise a reactive metal, while in another aspect, the pyrophoric material can comprise an organometallic. Illustrative and non-limiting examples of reactive metals include sodium, potassium, lithium, and the like.

Referring now to the organometallics, illustrative and non-limiting examples of organometallics include alkyl aluminums, alkyl lithiums, alkyl borons, and the like. For instance, specific pyrophoric organometallic compounds that can be present in the non-pyrophoric compositions disclosed herein include trimethylaluminum, triethylaluminum, tri-n-propylaluminum, tri-n-butylaluminum, triisobutylaluminum, triisohexylaluminum, tri-n-hexylaluminum, tri-n-octylaluminum, tri-n-decylaluminum, diethylaluminum hydride, diisobutylaluminum hydride, dimethylaluminum chloride, dimethylaluminum bromide, diethylaluminum fluoride, diethylaluminum chloride, diethylaluminum bromide, diethylaluminum iodide, di-n-propylaluminum chloride, di-n-butylaluminum chloride, diisobutylaluminum chloride, di-n-hexylaluminum chloride, diisohexylaluminum chloride, di-n-octylaluminum chloride, di-n-decylaluminum chloride, methylaluminum sesquichloride, methylaluminum sesquibromide, ethylaluminum sesquichloride, ethylaluminum sesquibromide, isobutylaluminum sesquichloride, ethylaluminum dichloride, ethylaluminum dibromide, isobutylaluminum dichloride, diethylaluminum ethoxide, diisobutylaluminum ethoxide, triethylborane, triisobutylborane, tri-n-butylborane, tri-n-octylborane, diethylboron methoxide, diethylboron isopropoxide, sec-butyllithium, tert-butyllithium, n-butylethylmagnesium, n-butylethylmagnesium n-butoxide, di-n-butylmagnesium, dimethylzinc, diethylzinc, di-n-propylzinc, di-n-butylzinc, and the like. Combinations of two or more of these organometallics also can be present in the non-pyrophoric composition, if desired.

The amount of the pyrophoric material in the non-pyrophoric composition is not particularly limited, and can range from as little as 0.1 wt. % up to and including 65 wt. %. More often, however, the amount of the pyrophoric material in the non-pyrophoric composition can range from 1 to 50 wt. % in one aspect, from 1 to 10 wt. % in another aspect, from 2 to 40 wt. % in another aspect, from 2 to 15 wt. % in another aspect, from 5 to 50 wt. % in another aspect, from 5 to 35 wt. % in another aspect, from 5 to 20 wt. % in another aspect, from 10 to 65 wt. % in another aspect, from 10 to 35 wt. % in yet another aspect, and from 10 to 20 wt. % in still another aspect.

For example, many commercially available metal alkyls are present in low carbon number alkane solvents (e.g., pentane, hexane, heptane) in amounts ranging from generally 5-10 wt. % up to and including 25-35 wt. %. However, low temperature storage conditions are normally used, particularly as the relative amount of the pyrophoric material is increased.

An objective of the present invention is to produce non-pyrophoric compositions that can be stored and shipped at higher temperatures, and can contain higher loadings of the pyrophoric material. Such non-pyrophoric compositions utilize alkane compositions (e.g., alkane solvents) that can have a beneficial combination of both a low viscosity and a high flash point, particularly as compared to conventional n-alkanes or polyalphaolefins (PAOs) of the same carbon number. Additionally or alternatively, the alkane composition that is present in the non-pyrophoric composition can have a beneficial combination of both a low viscosity and a low pour point, particularly as compared to conventional n-alkanes or polyalphaolefins (PAOs) of the same carbon number. Additionally or alternatively, the alkane composition in the non-pyrophoric composition can remain in the liquid phase over a wide range of temperatures and storage conditions. For instance, the alkane composition can have a beneficial combination of both a low pour point and a high flash point, particularly as compared to conventional n-alkanes or polyalphaolefins (PAOs) of the same carbon number. These alkane compositions are safer solvents for the storage and shipment of pyrophoric materials, offering an unmatched combination of viscosity, pour point, and flash point properties, while also allowing higher loadings of the pyrophoric material in the non-pyrophoric composition.

### Battery Systems

Battery systems consistent with aspects of this invention can utilize an alkane composition comprising C₁₆-C₃₆ alkanes (or C₁₆-C₃₂ alkanes) as a component of the battery system. The alkane composition comprising C₁₆-C₃₂ alkanes typically can be one of three alkane compositions disclosed in greater detail herein: a first alkane composition comprising at least 90 wt. % C₁₆ alkanes (hydrogenated 1-octene dimers), a second alkane composition comprising at least 90 wt. % C₂₄ alkanes (hydrogenated 1-octene trimers), or a third alkane composition comprising from 5 to 95 wt. % C₁₆ alkanes (hydrogenated 1-octene dimers) and (b) from 95 to 5 wt. % C₂₄ alkanes (hydrogenated 1-octene trimers), based on a total weight of the C₁₆ alkanes and the C₂₄ alkanes.

A first battery system of this invention, also referred to as a battery temperature control system, can comprise (i) a battery assembly in direct contact with (and surrounded by) an alkane composition comprising C₁₆-C₃₆ alkanes, the alkane composition contained within an outer casing, (ii) an inlet for introducing the alkane composition to the battery assembly, and (iii) an outlet for discharging the alkane composition from the battery assembly. The battery assembly is surrounded by the alkane composition, which serves as a cooling medium and heat sink for the battery (particularly during charge/discharge sequences), and this can improve battery life due to improved thermal control. The alkane composition can prevent exposure of the battery assembly and battery chemistry to water and oxygen/air, and therefore greatly reduce pyrophoricity.

Typically, although not required, the battery temperature control system can further comprise any suitable recirculation device for conveying the alkane composition to the inlet and for receiving the alkane composition from the outlet. The recirculation device ordinarily is a pump, and the pump can be of any typical design capable of conveying low viscosity liquids.

Since one function of the system and the alkane composition is to control or moderate the temperature of the battery, the battery temperature control system can further comprise a temperature sensor. In most instances, the battery temperature control system includes two or more temperature sensors. The sensor(s) can be positioned, for example, in any location in the system that is appropriate for measuring a temperature of the battery assembly, or in any location in the system that is appropriate for measuring a temperature of the alkane composition in direct contact with the battery assembly, or in any location in the system that is appropriate for measuring a temperature of the alkane composition discharged through the outlet, or any combination of these.

The battery temperature control system can further comprise a cooling device configured to remove heat from the alkane composition discharged through the outlet, and generally, the cooling device is positioned between the outlet and the recirculation device. The cooling device ordinarily is a radiator or a heat exchanger, and the radiator or the heat exchanger can be of any typical design capable of removing heat from low viscosity liquids.

Another optional component of the battery temperature control system is a controller. When the system includes the controller, the controller can be configured to adjust a flow rate of the alkane composition through the inlet based on (or according to) the temperature of the battery assembly, or based on the temperature of the alkane composition at any suitable location in the system. For instance, the controller can be configured to adjust a flow rate of the alkane composition through the inlet based on (or according to) the temperature of the alkane composition in direct contact with the battery assembly, or based on the temperature of the alkane composition discharged through the outlet.

As a non-limiting example, if the temperature of the battery assembly (or the temperature of the alkane composition in direct contact with the battery assembly, or the temperature of the alkane composition discharged through the outlet) is higher than the desired target or set point, the controller can increase the flow rate of the alkane composition through the system until the temperature of the battery assembly (or the temperature of the alkane composition in direct contact with the battery assembly, or the temperature of the alkane composition discharged through the outlet) decreases to the desired target or set point.

In addition to the viscosity, pour point, and flash point features of the alkane compositions that are described herein, there are several other benefits of using these alkane compositions in the battery temperature control system, and these can include a high degree of saturation, high oxidative stability and chemical inertness, high heat capacity, low electrical conductivity, and low density (low specific gravity).

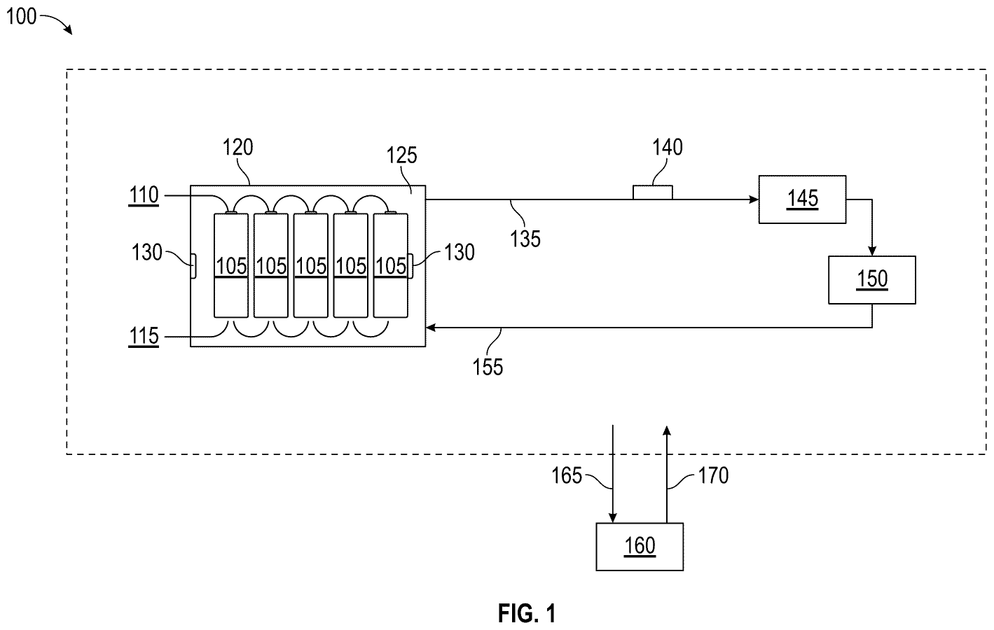

Referring now to FIG. 1, which illustrates a schematic diagram of a battery temperature control system 100 consistent with an aspect of the present disclosure. The battery temperature control system 100 includes a battery assembly 105 in direct contact with (and surrounded by) an alkane composition 125 with an outer casing 120 encompassing the alkane composition 125 and the battery assembly 105. Attached to the battery assembly 105 are positive terminal 110 and negative terminal 115. The battery temperature control system 100 includes an inlet 155 for introducing the alkane composition 125 to the battery assembly 105 (and into the outer casing 120), and an outlet 135 for discharging the alkane composition 125 from the battery assembly 105 (and exiting the outer casing 120).

A temperature sensor 130 is shown in FIG. 1 to measure the temperature of the battery assembly 105, and a temperature sensor 130 is affixed to the outer shell or casing 120 to measure a temperature of the alkane composition 125. Another temperature sensor 140 is present to measure a temperature of the alkane composition in the outlet 135. The system 100 further includes cooling device 145 to reduce the temperature of the alkane composition and a recirculation device 150 for receiving the alkane composition 125 from outlet 135 and conveying the alkane composition to the inlet 155.

Information or data 165 from temperatures sensors 130, 140 regarding the temperature of the battery assembly and/or the temperature of the alkane composition can be provided to controller 160, which can then control or adjust 170 a flow rate of the alkane composition through the inlet 155 based on the (or according to) the temperature information or data 165. For example, if the temperature is too high, such as above a target value, the controller 160 can increase the flow rate of the alkane composition to inlet 155 and to contact the battery assembly 105.

A second battery system of this invention can comprise (I) an internal battery assembly, (II) a separator film encapsulating the internal battery assembly, (III) an outer shell (or casing) surrounding the separator film and the internal battery assembly, and (IV) a liquid layer comprising an alkane composition comprising C₁₆-C₃₆ alkanes, the liquid layer positioned between the outer shell and the separator film.

A benefit of the alkane composition is to reduce the pyrophoricity of materials by absorbing the heat generated from the reaction. Further, due to their viscosity, the alkane compositions can effectively act as a passivating agent to provide a protective layer for the reactive materials from being exposed directly to the atmosphere. By slowing or inhibiting the reaction rate of lithium or other pyrophoric reagents reacting with the air, the alkane compositions can provide dramatically improved safety in regards to electrolyte or protective layers for reactive chemistry batteries.

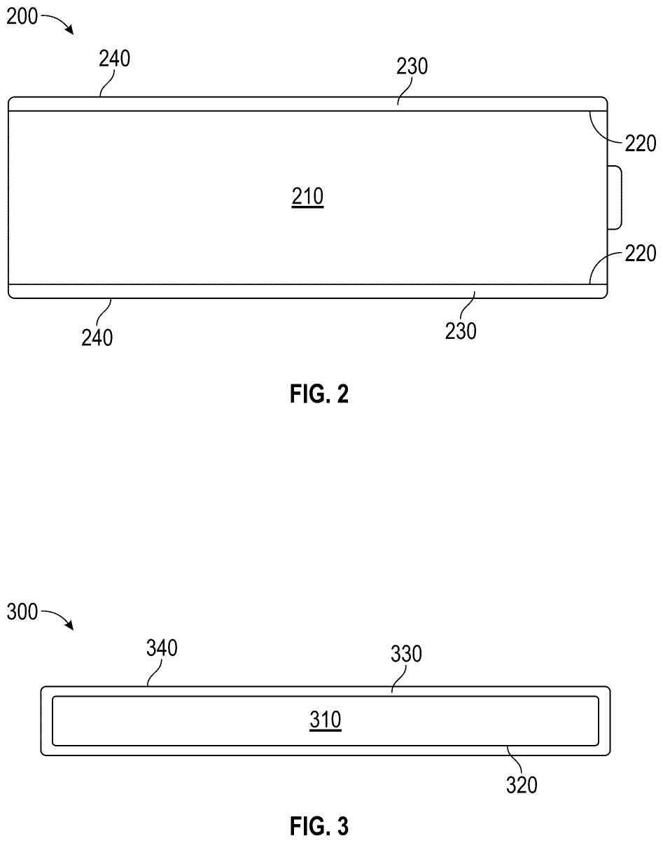

Referring now to FIG. 2, which illustrates a schematic diagram of a battery system 200 consistent with the present disclosure. This battery system 200 includes an internal battery assembly 210 (battery cell), a separator film 220 encapsulating the internal battery assembly, an outer shell 240 (or casing) surrounding the separator film 220 and the internal battery assembly 210, and a liquid layer 230 positioned between the outer shell 240 and the separator film 220. The liquid layer 230 comprises any alkane composition described herein.

FIG. 3 illustrates a schematic diagram of another battery system 300 consistent with the present disclosure. This battery system 300 includes an internal battery assembly 310 (battery pack), a separator film 320 encapsulating the internal battery assembly, an outer shell 340 (or casing) surrounding the separator film 320 and the internal battery assembly 310, and a liquid layer 330 positioned between the outer shell 340 and the separator film 320. The liquid layer 330 comprises any alkane composition described herein.

### Methods of Controlling Battery Temperature

The C₁₆₋₃₆ alkane compositions consistent with aspects of this invention are useful as protective and thermal control fluids in methods of controlling or moderating battery temperature. A first method can comprise (a) introducing an alkane composition into an inlet of a battery temperature control system, the battery temperature control system comprising an outer casing encompassing the alkane composition and a battery assembly, wherein the alkane composition comprises C₁₆-C₃₆ alkanes, (b) directly contacting the alkane composition with the battery assembly to regulate a temperature of the battery assembly, and (c) discharging the alkane composition from the battery assembly through an outlet of the battery temperature control system.

In step (a), the alkane composition is directed into the outer casing of a battery temperature control system via the inlet of the system. The outer casing encompasses the alkane composition and battery assembly such that the alkane and battery assembly are wholly enclosed therein. The alkane composition can comprise any of the alkane compositions described herein.

In step (b), the alkane composition is contacted with the battery assembly. This contacting allows the alkane composition to regulate a temperature of the battery assembly via absorption of heat energy. Generally, contacting the alkane composition with the battery assembly also passivates reactive chemistry within the battery assembly.

In step (c), the alkane composition can be discharged from the battery assembly through an outlet of the battery control system. In further aspects, the alkane composition can be received from the outlet and conveyed to the inlet of the battery temperature control system. In other words, the alkane composition can be recirculated throughout the battery temperature control system. The alkane composition may be transferred through the inlet and the outlet via any suitable mechanism for conveying low viscosity liquids. In some aspects, a recirculation device receives the alkane composition from the outlet and conveys the alkane composition to the inlet. In a non-limiting example, the alkane composition may be received and conveyed via a pump. As such, the alkane composition can proceed through the battery temperature control system at a particular a flow rate.

Advantageously, disclosed methods can be applied to further control or moderate battery temperature within the system. The first method can further comprise removing heat from the alkane composition that is discharged through the outlet. Heat removal can proceed when the alkane composition is received from the outlet and prior to being conveyed back to the inlet. Removing heat from the alkane composition can be achieved using any suitable device configured to remove heat from a low viscosity liquid, such as a radiator or a heat exchanger. Such excess heat removal allows the alkane composition to absorb heat energy from the battery system as the composition is recirculated throughout the battery system, thereby modifying the temperature of the system. In some aspects, a cooling device disposed between the outlet and the recirculation device can be used to remove heat from the circulating alkane composition.

A method of controlling or moderating battery temperature can further comprise adjusting a flow rate of the alkane composition through the inlet. The flow rate of the alkane can be adjusted according to the temperature of the battery assembly, or a temperature of the alkane composition, at any suitable location in the system. Adjusting the flow rate can alter the extent to which the alkane composition absorbs heat energy from the battery system as the composition is recirculated to the inlet of the battery system, thereby modifying the temperature of the system.

A method of controlling or moderating battery temperature can still further include measuring the temperature at various points within the battery temperature control system. In some aspects, a temperature of the battery assembly, or of the alkane composition directly in contact with the battery assembly, can be measured. These temperature measurements can be obtained using one or more temperature sensors within the battery system. The flow rate of the alkane composition through the inlet can then be modified based upon the measured temperatures to ultimately control the temperature of the battery assembly.

Methods can further comprise providing information or data from the one or more temperature sensors to a controller. A temperature of the battery assembly can accordingly be regulated or modified based upon the adjusted flow rate via the controller. More specifically, the controller can be used to adjust the flow rate of the alkane composition to the inlet to modify the temperature of the battery assembly (or the temperature of the alkane composition in direct contact with the battery assembly, or the temperature of the alkane composition discharged through the outlet) to any desired level or set point.

Additional methods of the present invention can include methods of temperature control of a battery system. A second method can comprise (a) providing a battery system comprising (I) an internal battery assembly, (III) a separator film encapsulating the internal battery assembly, and (III) an outer shell surrounding the separator film and the internal battery assembly, and (b) positioning a liquid layer between the outer shell and the separator film to regulate temperature, wherein the liquid layer can comprise an alkane composition comprising C₁₆-C₃₆. Direct contact of the alkane composition of the liquid layer allows the alkane composition to passivate reactive chemistry within the internal battery assembly.

The second method can further comprise removing heat generated from charging or discharging the internal battery assembly. The alkane composition of the liquid layer can remove heat generated by the internal battery assembly by absorbing heat. Accordingly, heat generated from charging or discharging the internal battery assembly is transferred to the liquid layer. This process of heat transfer or removal can moderate the temperature of the internal battery assembly thereby controlling the temperature of the battery assembly.

The alkane composition of the liquid layer can reduce pyrophoricity by providing a protective layer for reactive materials of the battery assembly, or battery cell, from being exposed to water and oxygen. As such, the liquid layer acts as a passivating agent and slows or inhibits reactivity of components of the internal battery assembly, which may comprise a battery cell. For instance, the liquid layer forms a protective layer so that reactive components of the internal battery assembly, such as lithium or other pyrophoric reagents, have a slowed reaction rate thereby improving the safety of reactive chemistry batteries. Furthermore, the liquid layer acts as a cooling medium for heat generated from charging or discharging the internal battery assembly, such as a battery cell comprising lithium or other pyrophoric reagents.

Generally, features of the first method and the second method (e.g., the alkane composition, outer casing, separator film, outer shell, and the battery assembly, among others) are independently described herein and these features can be combined in any combination to further describe the disclosed methods to control or moderate battery temperature or to reduce pyrophoricity of a battery assembly. Moreover, additional method steps can be performed before, during, and/or after any of the steps in any of the methods disclosed herein, and can be utilized without limitation and in any combination to further describe these methods, unless stated otherwise.

### C₁₆ Alkane Compositions

A first alkane composition comprising C₁₆ alkanes (hydrogenated 1-octene dimers) can be utilized in the non-pyrophoric compositions and battery systems disclosed herein. This first alkane composition can comprise at least 90 wt. % C₁₆ alkanes (hydrogenated 1-octene dimers), and this first alkane composition can be characterized by a 100° C. kinematic viscosity (KV100) in a range from 0.9 to 1.5 cSt, a 40° C. kinematic viscosity (KV40) in a range from 2 to 3.6 cSt, and a flash point in a range from 115 to 140° C. and/or a pour point in a range from −60 to −30° C. In some aspects, the first composition can comprise at least 92 wt. % C₁₆ alkanes, at least 95 wt. % C₁₆ alkanes, at least 97 wt. % C₁₆ alkanes, at least 98 wt. % C₁₆ alkanes, or at least 99 wt. % C₁₆ alkanes. Therefore, illustrative and non-limiting ranges for the amount of C₁₆ alkanes in the first composition can include from 90 to 99.5 wt. %, from 92 to 99 wt. %, from 95 to 99.9 wt. %, from 97 to 99.5 wt. %, from 98 to 99.9 wt. %, or from 99 to 99.9 wt. %, and the like.

Stated another way, the first alkane composition can comprise monomer units derived from 1-octene. The repeating units of the first alkane composition can be predominantly 1-octene monomer units. Accordingly, the first alkane composition can comprise at least 90 wt. %, and more often, at least 92 wt. %, at least 95 wt. %, at least 97 wt. %, or at least 98 wt. % 1-octene monomer units. Thus, for example, the first alkane composition can comprise at least 99 wt. % (or 100 wt. %) 1-octene monomer units.

The first alkane composition has a 100° C. kinematic viscosity (KV100) that generally falls within a range from 0.9 to 1.5 cSt. For instance, the first alkane composition can have a minimum KV100 of 0.9, 1, or 1.1 cSt; additionally or alternatively, the maximum KV100 of the first alkane composition can be 1.5, 1.4, or 1.3 cSt. Generally, the 100° C. kinematic viscosity of the first alkane composition can be in a range from any minimum KV100 disclosed herein to any maximum KV100 disclosed herein. Therefore, suitable non-limiting ranges for the 100° C. kinematic viscosity of the first alkane composition can include the following ranges: from 1 to 1.5 cSt, from 1 to 1.4 cSt, from 1 to 1.3 cSt, from 1.1 to 1.5 cSt, from 1.1 to 1.4 cSt, or from 1.1 to 1.3 cSt. KV100 is determined in accordance with ASTM D7042-04.

The 40° C. kinematic viscosity (KV40) of the first alkane composition can fall within a range from 2 to 3.6 cSt. For instance, the first alkane composition can have a minimum KV40 of 2, 2.2, 2.4, 2.6, or 2.7 cSt; additionally or alternatively, the maximum KV40 of the first alkane composition can be 3.6, 3.4, 3.2, 3, or 2.9 cSt. Generally, the 40° C. kinematic viscosity of the first alkane composition can be in a range from any minimum KV40 disclosed herein to any maximum KV40 disclosed herein. Therefore, suitable non-limiting ranges for the 40° C. kinematic viscosity of the first alkane composition can include the following ranges: from 2 to 3.4 cSt, from 2.2 to 3.6 cSt, from 2.2 to 3.4 cSt, from 2.4 to 3.4 cSt, from 2.4 to 3.2 cSt, from 2.4 to 3 cSt, from 2.6 to 3.2 cSt, from 2.6 to 3 cSt, or from 2.7 to 2.9 cSt. KV40 is determined in accordance with ASTM D7042-04.

The flash point of the first alkane composition typically ranges from 115 to 140° C. For instance, the minimum flash point of the first alkane composition can be 115, 120, or 125° C.; additionally or alternatively, the maximum flash point can be 140, 135, or 130° C. Generally, the flash point of the first alkane composition can be in a range from any minimum flash point temperature disclosed herein to any maximum flash point temperature disclosed herein. Therefore, suitable non-limiting ranges for the flash point of the first alkane composition can include the following ranges: from 115 to 135° C., from 115 to 130° C., from 120 to 140° C., from 120 to 135° C., from 120 to 130° C., from 125 to 135° C., or from 125 to 130° C. The flash point is determined in accordance with ASTM D92.

The pour point of the first alkane composition typically can fall within a range from −60 to −30° C. For instance, the minimum pour point of the first alkane composition can be −60, −55, or −50° C.; additionally or alternatively, the maximum pour point can be −30, −35, or −40° C. Generally, the pour point of the first alkane composition can be in a range from any minimum pour point temperature disclosed herein to any maximum pour point temperature disclosed herein. Therefore, suitable non-limiting ranges for the pour point of the first alkane composition can include the following ranges: from −60 to −35° C., from −60 to −40° C., from −55 to −30° C., from −55 to −35° C., from −55 to −40° C., from −50 to −30° C., from −50 to −35° C., or from −50 to −40° C. The pour point is determined in accordance with ASTM D5950.

While not limited thereto, the first alkane composition often has a density at 15° C. in a range of from 0.773 to 0.782 g/cc. In an aspect, the first alkane composition can have a minimum density of 0.773, 0.774, 0.775, 0.776, or 0.777 g/cc; additionally or alternatively, the maximum density of the first alkane composition can be 0.782, 0.781, 0.780, 0.779, or 0.778 g/cc. Generally, the 15° C. density of the first alkane composition can be in a range from any minimum density disclosed herein to any maximum density disclosed herein. Therefore, suitable non-limiting ranges for the density at 15° C. of the first alkane composition can include the following ranges: from 0.774 to 0.781 g/cc, from 0.775 to 0.780 g/cc, from 0.776 to 0.779 g/cc, from 0.776 to 0.778 g/cc, from 0.777 to 0.779 g/cc, or from 0.777 to 0.778 g/cc. Density is determined in accordance with ASTM D4052.

### C₂₄ Alkane Compositions

A second alkane composition comprising C₂₄ alkanes (hydrogenated 1-octene trimers) can be utilized in the non-pyrophoric compositions and battery systems disclosed herein. The second alkane composition disclosed herein can comprise at least 90 wt. % C₂₄ alkanes (hydrogenated 1-octene trimers), and this second alkane composition can be characterized by a 100° C. kinematic viscosity (KV100) in a range from 2 to 3 cSt, a 40° C. kinematic viscosity (KV40) in a range from 7.7 to 9.7 cSt, and a flash point in a range from 185 to 215° C. and/or a pour point in a range from −95 to −70° C. In some aspects, the second composition can comprise at least 92 wt. % C₂₄ alkanes, at least 95 wt. % C₂₄ alkanes, at least 97 wt. % C₂₄ alkanes, at least 98 wt. % C₂₄ alkanes, or at least 99 wt. % C₂₄ alkanes. Therefore, illustrative and non-limiting ranges for the amount of C₂₄ alkanes in the second composition can include from 90 to 99.5 wt. %, from 92 to 99 wt. %, from 95 to 99.9 wt. %, from 97 to 99.5 wt. %, from 98 to 99.9 wt. %, or from 99 to 99.9 wt. %, and the like.

Stated another way, the second alkane composition can comprise monomer units derived from 1-octene. The repeating units of the second alkane composition can be predominantly 1-octene monomer units. Accordingly, the second alkane composition can comprise at least 90 wt. %, and more often, at least 92 wt. %, at least 95 wt. %, at least 97 wt. %, or at least 98 wt. % 1-octene monomer units. Thus, for example, the second alkane composition can comprise at least 99 wt. % (or 100 wt. %) 1-octene monomer units.

The second alkane composition has a 100° C. kinematic viscosity (KV100) that generally falls within a range from 2 to 3 cSt. For instance, the second alkane composition can have a minimum KV100 of 2, 2.1, 2.2, 2.3, or 2.4 cSt; additionally or alternatively, the maximum KV100 of the second alkane composition can be 3, 2.9, 2.8, 2.7, 2.6, or 2.5 cSt. Generally, the 100° C. kinematic viscosity of the second alkane composition can be in a range from any minimum KV100 disclosed herein to any maximum KV100 disclosed herein. Therefore, suitable non-limiting ranges for the 100° C. kinematic viscosity of the second alkane composition can include the following ranges: from 2.1 to 2.9 cSt, from 2.2 to 2.8 cSt, from 2.3 to 2.7 cSt, from 2.3 to 2.6 cSt, from 2.3 to 2.5 cSt, from 2.4 to 2.7 cSt, from 2.4 to 2.6 cSt, or from 2.4 to 2.5 cSt. KV100 is determined in accordance with ASTM D7042-04.

The 40° C. kinematic viscosity (KV40) of the second alkane composition can fall within a range from 7.7 to 9.7 cSt. For instance, the second alkane composition can have a minimum KV40 of 7.7, 7.8, 7.9, 8, 8.1, 8.2, 8.3, 8.4, 8.5, or 8.6 cSt; additionally or alternatively, the maximum KV40 of the second alkane composition can be 9.7, 9.6, 9.5, 9.4, 9.3, 9.2, 9.1, 9, 8.9, or 8.8 cSt. Generally, the 40° C. kinematic viscosity of the second alkane composition can be in a range from any minimum KV40 disclosed herein to any maximum KV40 disclosed herein. Therefore, suitable non-limiting ranges for the 40° C. kinematic viscosity of the second alkane composition can include the following ranges: from 7.8 to 9.6 cSt, from 7.9 to 9.5 cSt, from 8 to 9.4 cSt, from 8.1 to 9.3 cSt, from 8.2 to 9.2 cSt, from 8.3 to 9.1 cSt, from 8.4 to 9 cSt, from 8.5 to 8.9 cSt, or from 8.6 to 8.8 cSt. KV40 is determined in accordance with ASTM D7042-04.

The flash point of the second alkane composition typically ranges from 185 to 215° C. For instance, the minimum flash point of the second alkane composition can be 185, 188, 190, 192, or 194° C.; additionally or alternatively, the maximum flash point can be 215, 205, 202, 200, or 198° C. Generally, the flash point of the second alkane composition can be in a range from any minimum flash point temperature disclosed herein to any maximum flash point temperature disclosed herein. Therefore, suitable non-limiting ranges for the flash point of the second alkane composition can include the following ranges: from 185 to 205° C., from 185 to 200° C., from 188 to 202° C., from 190 to 215° C., from 190 to 205° C., from 192 to 200° C., or from 194 to 198° C. The flash point is determined in accordance with ASTM D92.

The pour point of the second alkane composition typically can fall within a range from −95 to −70° C. For instance, the minimum pour point of the second alkane composition can be −95, −90, −88, or −85° C.; additionally or alternatively, the maximum pour point can be −70, −75, −78, or −80° C. Generally, the pour point of the second alkane composition can be in a range from any minimum pour point temperature disclosed herein to any maximum pour point temperature disclosed herein. Therefore, suitable non-limiting ranges for the pour point of the second alkane composition can include the following ranges: from −90 to −70° C., from −90 to −75° C., from −88 to −75° C., from −88 to −78° C., or from −85 to −80° C. The pour point is determined in accordance with ASTM D5950.

While not limited thereto, the second alkane composition often has a density at 15° C. in a range of from 0.799 to 0.808 g/cc. In an aspect, the second alkane composition can have a minimum density of 0.799, 0.800, 0.801, 0.802, or 0.803 g/cc; additionally or alternatively, the maximum density of the second alkane composition can be 0.808, 0.807, 0.806, 0.805, or 0.804 g/cc. Generally, the 15° C. density of the second alkane composition can be in a range from any minimum density disclosed herein to any maximum density disclosed herein. Therefore, suitable non-limiting ranges for the density at 15° C. of the second alkane composition can include the following ranges: from 0.799 to 0.808 g/cc, from 0.800 to 0.807 g/cc, from 0.801 to 0.806 g/cc, from 0.802 to 0.805 g/cc, from 0.802 to 0.804 g/cc, from 0.803 to 0.805 g/cc, or from 0.803 to 0.804 g/cc. Density is determined in accordance with ASTM D4052.

### C₁₆-C₂₄ Alkane Compositions

A third alkane composition comprising C₁₆ alkanes (hydrogenated 1-octene dimers) and C₂₄ alkanes (hydrogenated 1-octene trimers) can be utilized in the non-pyrophoric compositions and battery systems disclosed herein. The third alkane composition disclosed herein can comprise (a) from 5 to 95 wt. % C₁₆ alkanes (hydrogenated 1-octene dimers), and (b) from 95 to 5 wt. % C₂₄ alkanes (hydrogenated 1-octene trimers), and these weight percentages are based on the total weight of the C₁₆ alkanes and the C₂₄ alkanes. For instance, the third alkane composition can have a minimum amount of C₁₆ alkanes of 5, 10, 15, 25, 35, or 50 wt. %; additionally or alternatively, the maximum amount of C₁₆ alkanes in the third alkane composition can be 95, 90, 85, 75, or 65 wt. %. Generally, the amount of the C₁₆ alkanes in the third alkane composition can be in a range from any minimum amount disclosed herein to any maximum amount disclosed herein. Therefore, suitable non-limiting ranges for the amount of the C₁₆ alkanes in the third alkane composition can include the following ranges: from 10 to 90 wt. %, from 50 to 90 wt. %, from 15 to 85 wt. %, from 50 to 85 wt. %, from 25 to 75 wt. %, or from 35 to 65 wt. %, of the C₁₆ alkanes. As above, these weight percentages are based on the total weight of the C₁₆ alkanes and the C₂₄ alkanes.

Additionally or alternatively, the third alkane composition can comprise, based on the total weight of the composition, (a) from 40 to 90 wt. % of the C₁₆ alkanes (hydrogenated 1-octene dimers) and (b) from 10 to 60 wt. % of the C₂₄ alkanes (hydrogenated 1-octene trimers). Based on the total weight of the composition, other suitable amounts of the C₁₆ alkanes in the third alkane composition can include, but are not limited to, from 50 to 85 wt. %, from 55 to 95 wt. %, or from 58 to 80 wt. % of the C₁₆ alkanes. Additionally or alternatively, based on the total weight of the composition, other suitable amounts of the C₂₄ alkanes in the third alkane composition can include, but are not limited to, from 10 to 50 wt. %, from 10 to 30 wt. %, or from 14 to 30 wt. % of the C₂₄ alkanes. As one of skill in the art would readily recognize, the total of these and other components does not exceed 100 wt. %.

Optionally, the third alkane composition can further comprise (c) C₃₂ alkanes (hydrogenated 1-octene tetramers). When present, the amount of the C₃₂ alkanes in the third composition can fall within a range from 0.5 to 20 wt. % C₃₂ alkanes, based on the total weight of the composition. Other suitable amounts of the C₃₂ alkanes in the third alkane composition can include, but are not limited to, from 1 to 12 wt. %, from 1 to 9 wt. %, or from 2 to 8 wt. % C₃₂ alkanes. These weight percentages are based on the total weight of the third alkane composition.

The third alkane composition has a 100° C. kinematic viscosity (KV100) that generally falls within a range from 1 to 2.9 cSt. For instance, the third alkane composition can have a minimum KV100 of 1, 1.1, 1.2, or 1.3 cSt; additionally or alternatively, the maximum KV100 of the third alkane composition can be 2.9, 2.5, 2, or 1.6 cSt. Generally, the 100° C. kinematic viscosity of the third alkane composition can be in a range from any minimum KV100 disclosed herein to any maximum KV100 disclosed herein. Therefore, suitable non-limiting ranges for the 100° C. kinematic viscosity of the third alkane composition can include the following ranges: from 1 to 2.9 cSt, from 1 to 2.5 cSt, from 1 to 2 cSt, from 1 to 1.6 cSt, from 1.1 to 2.5 cSt, from 1.1 to 2 cSt, from 1.1 to 1.6 cSt, from 1.2 to 2.5 cSt, from 1.2 to 2 cSt, from 1.3 to 2.9 cSt, or from 1.3 to 2.5 cSt. KV100 is determined in accordance with ASTM D7042-04.

The 40° C. kinematic viscosity (KV40) of the third alkane composition can fall within a range from 2 to 9.5 cSt. For instance, the third alkane composition can have a minimum KV40 of 2, 2.5, 3, or 4 cSt; additionally or alternatively, the maximum KV40 of the third alkane composition can be 9.5, 9, 8.5, 8, 7, 6, 5, or 4 cSt. Generally, the 40° C. kinematic viscosity of the third alkane composition can be in a range from any minimum KV40 disclosed herein to any maximum KV40 disclosed herein. Therefore, suitable non-limiting ranges for the 40° C. kinematic viscosity of the third alkane composition can include the following ranges: from 2 to 9.5 cSt, from 2 to 8.5 cSt, from 2.5 to 8.5 cSt, from 2.5 to 7 cSt, from 2.5 to 5 cSt, from 2.5 to 4 cSt, from 3 to 8 cSt, from 3 to 6 cSt, from 4 to 9 cSt, or from 4 to 6 cSt. KV40 is determined in accordance with ASTM D7042-04.

The flash point of the third alkane composition typically ranges from 100 to 200° C. For instance, the minimum flash point of the third alkane composition can be 100, 120, 130, or 140° C.; additionally or alternatively, the maximum flash point can be 200, 190, 180, 160, or 150° C. Generally, the flash point of the third alkane composition can be in a range from any minimum flash point temperature disclosed herein to any maximum flash point temperature disclosed herein. Therefore, suitable non-limiting ranges for the flash point of the third alkane composition can include the following ranges: from 100 to 200° C., from 100 to 150° C., from 120 to 180° C., from 120 to 160° C., from 130 to 190° C., from 130 to 160° C., or from 140 to 180° C. The flash point is determined in accordance with ASTM D92.

The pour point of the third alkane composition typically can fall within a range from −85 to −35° C. For instance, the minimum pour point of the third alkane composition can be −85, −80, −75, or −70° C.; additionally or alternatively, the maximum pour point can be −35, −40, or −45° C. Generally, the pour point of the third alkane composition can be in a range from any minimum pour point temperature disclosed herein to any maximum pour point temperature disclosed herein. Therefore, suitable non-limiting ranges for the pour point of the third alkane composition can include the following ranges: from −85 to −35° C., from −80 to −40° C., from −75 to −40° C., from −75 to −45° C., or from −70 to −45° C. The pour point is determined in accordance with ASTM D5950.

While not limited thereto, the third alkane composition often has a density at 15° C. in a range of from 0.776 to 0.805 g/cc. In an aspect, the third alkane composition can have a minimum density of 0.776, 0.778, or 0.780 g/cc; additionally or alternatively, the maximum density of the third alkane composition can be 0.805, 0.803, 0.800, 0.795, or 0.790 g/cc. Generally, the 15° C. density of the third alkane composition can be in a range from any minimum density disclosed herein to any maximum density disclosed herein. Therefore, suitable non-limiting ranges for the density at 15° C. of the third alkane composition can include the following ranges: from 0.776 to 0.805 g/cc, from 0.778 to 0.803 g/cc, from 0.778 to 0.790 g/cc, from 0.780 to 0.803 g/cc, from 0.780 to 0.800 g/cc, from 0.780 to 0.795 g/cc, or from 0.780 to 0.790 g/cc. Density is determined in accordance with ASTM D4052.

### Additives

Optionally, the first alkane composition, the second alkane composition, and the third alkane composition can further comprise an additive (one additive, two or more additives). For instance, in one aspect, the first alkane composition can comprise C₁₆ alkanes and an additive (one additive, two or more additives). In another aspect, the second alkane composition can comprise C₂₄ alkanes and an additive (one additive, two or more additives). In yet another aspect, the third alkane composition can comprise C₁₆-C₂₄ alkanes and an additive (one additive, two or more additives).

In addition to the alkane components, the first, second, and third alkane compositions can contain any suitable amount of a single additive or any suitable amounts of two or more additives. As those skilled in the art would readily recognize, the specific additive (or additives) can be included to impart specific properties to the alkane compositions, depending of course upon the end-use application for the alkane compositions. Illustrative and non-limiting examples of suitable additives can include an anti-wear additive, a dispersant, a viscosity modifier, a friction modifier/reducer, a detergent, a demulsifier, a defoamant, an antioxidant, an extreme pressure agent, a rust/corrosion inhibitor, a metal passivator, a pour point depressant, or a thickener. Any combination of two or more of these additives also can be present.

As to additives that can be utilized along with the alkane compositions, general information on additives that can be used herein can be found in “Lubricants and Lubrications,” T. Mang and W. Dresel, eds., Wiley-VCH GmbH, Weinheim (2001); “Lubrication Fundamentals,” Second Edition, Revised and Expanded, ExxonMobil Lubricants and Specialties, D. M. Pirro, A. A. Wessol, CRC Press 2001; “Fuels and Lubricants Handbook: Technology, Properties, Performance, and Testing” edited by George E. Totten, Steven R. Westbrook, Rajesh J. Shah, ASTM (2003), ISBN 0-8031-2096-6; Chapter 9 Additives and Additive Chemistry, pp. 199-248, “Lubricants and Related Products,” Klamann, Verlag Chemie, Deerfield Beach, FL, ISBN 0-89573-177-0; “Lubricant Additives” by M. W. Ranney, published by Noyes Data Corporation of Parkridge, N. J. (1973); and “Lubricant Additives,” C. V. Smallheer and R. K. Smith, published by the Lezius-Hiles Co. of Cleveland, OH (1967).

Viscosity index improvers (also known as viscosity modifiers and viscosity improvers) can provide alkane compositions with high and low temperature operability. These additives can impart shear stability at elevated temperatures and acceptable viscosity at low temperatures. Suitable viscosity index improvers can include high molecular weight hydrocarbons, olefin polymers and copolymers, polyesters, and viscosity index improver dispersants that function as both a viscosity index improver and a dispersant. Viscosity index improvers can have molecular weights ranging from 10,000 Da to 1,000,000 Da, from 20,000 Da to 500,000 Da, or from 50,000 Da to 200,000 Da.

Viscosity index improvers can include polymers and copolymers of methacrylate, butadiene, olefins, or alkylated styrenes. Exemplary viscosity index improvers include, but are not limited to, polyisobutylene, copolymers of ethylene and propylene, hydrogenated block copolymers of styrene and isoprene, polyacrylates (e.g., polymers and/or copolymers of various chain length acrylates), and polymethacrylates (e.g., polymers and/or copolymers of various chain length alkyl methacrylates). Generally, the viscosity index improver can be used in an amount of from 0.01 wt. % to 6 wt. %, from 0.01 to 5 wt. %, or from 0.01 to 4 wt. %, based upon the total weight of the alkane composition.

Dispersants are additives utilized to maintain oxidation products (produced during use of the alkane composition) in suspension in the alkane compositions to prevent the accumulation of debris that could score bearings, block lubricant pathways, prevent deposit formations, inhibit corrosive wear by neutralizing acidic products (e.g., combustion products), and other types of damage. Dispersants can be ash-containing or ashless in character. Dispersants can include, but are not limited to, alkenylsuccinic acid or anhydride derivatives (e.g., succinimides, succinate esters, or succinate ester amides), phenates, Mannich-Base condensates (e.g., the condensation products of alkylphenols, amines and aldehydes), hydrocarbyl substituted amines, sulfonates, sulfurized phenates, salicylates, naphthenates, stearates, carbamates, thiocarbamates, and phosphorus derivatives in metallic and non-metallic versions. Suitable dispersants can contain a polar group attached to a relatively high molecular weight hydrocarbon chain where the polar group contains at least one element of nitrogen, oxygen, or phosphorus. Patents describing dispersants which can be utilized in the alkane compositions include, but are not limited to, U.S. Pat. Nos. 3,036,003; 3,087,936; 3,172,892; 3,200,107; 3,219,666; 3,254,025,; 3,272,746; 3,275,554; 3,322,670; 3,329,658; 3,316,177; 3,438,757; 3,341,542; 3,413,347; 3,438,757; 3,444,170; 3,449,250; 3,454,555; 3,454,607; 3,519,565; 3,541,012; 3,565,804; 3,630,904; 3,632,511; 3,652,616; 3,666,730; 3,687,849; 3,697,574; 3,702,300; 3,703,536; 3,704,308; 3,725,277; 3,725,480; 3,726,882; 3,751,365; 3,755,433; 3,756,953; 3,787,374; 3,798,165; 3,803,039; 3,822,209; 3,948,800; 4,100,082; 4,234,435; 4,426,305; 4,454,059; 4,767,551; and 5,705,458, among others. Generally, dispersants can be used in an amount from 0.1 wt. % to 18 wt. %, 0.1 wt. % to 15 wt. %, or 0.1 wt. % to 8 wt. %, based upon the total weight of the alkane composition.

Detergents are additives utilized to maintain overall cleanliness by keeping sludge, carbon and deposit precursors suspended in the alkane compositions. Many detergents are chemically similar to dispersants. Detergents which can be utilized in the alkane compositions can include the alkali or alkaline earth metal of sulfates, sulfonates, phenates, carboxylates, phosphates, carboxylic acids, and salicylates. For example, suitable detergents can include, but are not limited to, the sulfonated alkylaromatic hydrocarbons, alkyl phenols, sulfurized alkyl phenols treated with an alkaline earth metal hydroxide or oxide (e.g., CaO, Ca(OH)₂, BaO, Ba(OH)₂, MgO, or Mg(OH)₂). Sulfonated alkylaromatic compounds can be prepared from sulfonic acids obtained by sulfonation of C₉ to C₈₀ (or C₆ to C₆₀) alkyl substituted aromatic hydrocarbons (having one or more than one alkyl groups) where the alkyl groups independently can be C₃ to C₇₀ alkyl groups and the aromatic portion can be benzene, toluene, xylene, naphthalene, or biphenyl. Alkyl phenol and/or sulfurized alkyl phenols can have one or more C₄ to C₃₀ alkyl groups. The detergents utilized in the alkane compositions can be neutral (i.e., produced using only enough alkali or alkaline earth compound to neutralize the sulfonated alkylaromatic compound, alkyl phenol, or sulfurized alkyl phenol) or can be overbased (i.e., produced using more alkali or alkaline earth compound than necessary to neutralize the sulfonated alkylaromatic compound, alkyl phenol, or sulfurized alkyl phenol). Generally, detergents can be used in an amount from 0.01 wt. % to 6.0 wt. %, 0.05 wt. % to 5.0 wt. %, or 0.1 to 4 wt. %, based upon the total weight of the alkane composition.

Defoamants (or anti-foam agents) are additives utilized to retard the formation of stable foam in the alkane compositions. Defoamants which can be utilized in the alkane compositions can include, but are not limited to, silicone compounds (e.g., polysiloxanes, such as silicon oil or polydimethyl siloxane, among others) and organic polymers. Defoamants can be utilized in conjunction with demulsifiers. Generally, the maximum amount of defoamants can be 1 wt. %, 0.5 wt. %, or 0.1 wt. %, based upon the total weight of the alkane composition.

Antioxidants are additives utilized to retard the oxidative degradation of the alkanes or other oils in the alkane compositions. Oxidative degradation can produce deposits on metal surfaces, sludge, and/or increase the viscosity of the alkane composition. Antioxidants which can be utilized in the alkane compositions include, but are not limited to, hindered phenols (ashless); neutral or basic metal salts of hindered phenols; hindered phenolic carboxylic acid (e.g., propionic acid) ester derivatives; bis-hindered phenols; alkylated and non-alkylated aromatic amines; sulfurized alkyl phenols; alkali or alkaline earth metal salts of sulfurized alkyl phenols; copper dihydrocarbyl thio or dithio-phosphates; copper salts of carboxylic acids (natural or synthetic); and copper salts of dithiacarbamates, dithiocarbamates, sulphonates, phenates, acetylacetonates and alkenyl succinic acids or anhydrides (neutral, basic or acidic). Patents describing antioxidants which can be utilized in the alkane compositions include, but are not limited to, U.S. Pat. Nos. 4,798,684 and 5,084,197. Generally, the antioxidants can be used in an amount from 0.01 wt. % to 5 wt. %, from 0.01 to 2.5 wt. %, or from 0.01 wt. % to 1.5 wt. %, based upon the total weight of the alkane composition.

Anti-wear additives and extreme pressure additives are compounds utilized to reduce friction and wear of metal parts. Anti-wear additives and extreme pressure additives which can be utilized in the alkane compositions include, but are not limited to, metal alkylthiophosphates (e.g., a zinc alkylthiophosphonate having a C₁ to C₁₈ alkyl group), metal dialkyldithiophosphates (e.g., a zinc alkylthiophosphonate having C₁ to C₁₈ alkyl groups), sulfurized C₃ to C₃₀ aliphatic or arylaliphatic hydrocarbon olefins (acyclic or cyclic), polysulfides of thiophosphorus acids, polysulfides of thiophosphorus acid esters, phosphorothionyl disulfides, alkylthiocarbamoyl compounds (e.g., bis(dibutyl)thiocarbamoyl) in combination with a molybdenum compound (e.g., oxymolybdenum diisopropylphosphorodithioate sulfide) and a phosphorus ester (e.g., dibutyl hydrogen phosphite, for example), thiocarbamates, thiocarbamate/molybdenum complexes (e.g., moly-sulfur alkyl dithiocarbamate trimer complexes), and/or glycerol ester (e.g., mono-, di-, and tri-oleates, mono-palmitates and mono-myristates). Patents describing anti-wear additives and/or extreme pressure additives which can be utilized in the alkane compositions include, but are not limited to, U.S. Pat. Nos. 2,443,264; 2,471,115; 2,526,497; 2,591,577; 3,770,854; 4,501,678; 4,941,984; 5,034,141; 5,034,142; 5,084,197; and 5,693,598. Generally, the total amount of anti-wear additives and extreme pressure additives used in the alkane compositions can be from 0.01 wt. % to 8 wt. %, from 0.01 to 5 wt. %, or from 0.01 wt. % to 4 wt. %, based upon the total weight of the alkane composition. In an aspect, the anti-wear additive is phosphorus-based.

Anti-rust additives are additives that protect lubricated metal surfaces against chemical attack by water or other contaminants. Anti-rust additives can function by 1) wetting the metal surface with a film of oil, 2) absorbing water into a water-in-oil emulsion, and/or 3) adhering to the metal to form a non-reactive surface, among other potential modes of function. Anti-rust additives which can be utilized in the alkane compositions include, but are not limited to, zinc dithiophosphates, metal phenolates, basic metal sulfonates, fatty acids, and amines. Generally, the amount of anti-rust additives used in the alkane compositions can be from 0.01 wt. % to 5 wt. %, from 0.01 wt. % to 2.5 wt. %, or from 0.01 wt. % to 1.5 wt. %, based upon the total weight of the composition.

Corrosion inhibitors are additives that reduce the degradation of metallic parts that are in contact with the alkane compositions. Corrosion inhibitors which can be utilized in the alkane compositions include, but are not limited to, thiadiazoles and triazoles. Patents describing corrosion inhibitors which can be utilized in the alkane compositions include, but are not limited to, U.S. Pat. Nos. 2,719,125; 2,719,126; and 3,087,932. Generally, the amount of corrosion inhibitors used in the alkane compositions can be from 0.01 wt. % to 5 wt. %, from 0.01 wt. % to 2.5 wt. %, or from 0.01 wt. % to 1.5 wt. %, based upon the total weight of the composition. The corrosion inhibitors also can improve anti-wear and EP properties.

Pour point depressants are additives that reduce the minimum temperature at which the alkane compositions will flow or can be poured. Pour point depressants which can be utilized in the alkane compositions include, but are not limited to, polymethacrylates, polyacrylates, polyarylamides, condensation products of haloparaffin waxes and aromatic compounds, vinyl carboxylate polymers, and terpolymers of dialkylfumarates, vinyl esters of fatty acids and allyl vinyl ethers. Patents describing pour point depressants which can be utilized in the alkane compositions include, but are not limited to, U.S. Pat. Nos. 1,815,022; 2,015,748; 2,191,498; 2,387,501; 2,655,479; 2,666,746; 2,721,877; 2,721,878; and 3,250,715. Generally, the amount of the pour point depressant used in the alkane compositions can be from 0.01 wt. % to 5 wt. %, from 0.01 wt. % to 2.5 wt. %, or from 0.01 wt. % to 1.5 wt. %, based upon the total weight of the composition.

Seal compatibility additives are compounds that swell elastomeric seals and can function by causing a chemical reaction in the fluid or a physical change in the seal elastomer. Seal compatibility additives which can be utilized in the alkane compositions include, but are not limited to, organic phosphates, aromatic esters, aromatic hydrocarbons, esters (e.g., butylbenzyl phthalate), and polybutenyl succinic anhydride. Generally, the amount of the seal compatibility additive used in the alkane composition can be from 0.01 wt. % to 3 wt. %, from 0.01 wt. % to 2.5 wt. %, or from 0.01 wt. % to 2 wt. %, based upon the total weight of the composition.

If desired, the alkane composition can be combined with one or more other base oils. One base oil can be used or two or more different base oils can be used. Generally, when a base oil is present in the alkane composition, but not specifically limited thereto, the amount of the base oil (or total base oils, if two or more) in the alkane composition is in a range from 1 to 45 wt. %; alternatively, from 5 to 40 wt. %; alternatively, from 5 to 25 wt. %; or alternatively, from 10 to 30 wt. %.

In an aspect, the base oil can be a Group I Base Oil, a Group II Base Oil, a Group III Base Oil, a Group IV Base Oil, or a Group V Base Oil, as well as any combination thereof. These base oil groups are those as designated by The American Petroleum Institute (API). In another aspect, the base oil can be a polyalphaolefin (i.e., a polyalphaolefin different from the alkane compositions described herein), a GTL fluid, or a combination thereof. Additional information on GTL fluids that optionally can be used in the alkane compositions disclosed herein can be found in “GTL—an emerging route to clean fuels and products,” Hydrocarbon Asia, November/December 2003, p. 44-49; “Shell gas-to-liquid (GTL) base oil converting natural gas to base oils for lubricants,” Shell Lubricants; and “The Shell GTL Process: Towards a World Scale Project in Qatar: the Pearl Project,” DGMK-Conference, Synthesis Gas Chemistry, Oct. 4-6, 2006, Dresden.

The alkane compositions disclosed herein can be used in a variety of formulations or products for a diverse range of applications and industries. As a non-limiting example, the alkane composition can be a lubricant composition, and the lubricant composition can be utilized in transmission or drive train fluids, which is inclusive of fluids or lubricants for transmissions (e.g., automobile and truck/bus manual/clutch transmissions and automatic transmissions, farm machinery transmissions), gear boxes (e.g., automobile and truck/bus gears, farm machinery gears), axle assemblies (e.g., transaxles, drive axles), differentials, as well as related hydraulic fluids (e.g., for farm equipment and construction vehicles); engine oils (e.g., for internal combustion engines such as gasoline or diesel or hybrid engines) in automobiles, trucks/busses, farm equipment, aircraft, and so forth; and greases (e.g., for any vehicle application such as automobiles, trucks/busses, farm equipment, aircraft). As another non-limiting example, the alkane composition can be an immersion coolant composition.

### Catalyst Systems and Oligomerization Processes

The low viscosity PAOs or alkane compositions consistent with aspects of this invention can be produced using any suitable catalyst system. Illustrative examples of catalyst systems that can be used to produce the disclosed alkane compositions can contain BF₃; an alkylaluminum, an alkylaluminum halide, an aluminum trihalide, or any combination thereof; a supported metal oxide; an acidic ionic liquid; a metallocene compound; a clay, an acidic clay, or an acid washed clay; or an acidic ion exchange resin. Representative catalysts are described, for instance, in US 2020/0207682 A1.

A representative process that can be used to produce the alkane compositions can comprise contacting an olefin feedstock comprising at least 98 wt. % C₈ olefins (e.g., 95+ wt. % 1-octene) with a suitable catalyst system (e.g., a metallocene-based catalyst system) under oligomerization conditions to form an oligomer product, isolating a C₁₆ olefin product (or a C₂₄ olefin product, or a mixed C₁₆-C₂₄ olefin product) from the oligomer product using one or more separation steps, and hydrogenating the respective olefin product to produce the first C₁₆ alkane composition (or the second C₂₄ alkane composition, or the third mixed C₁₆-C₂₄ alkane composition). Unreacted 1-octene monomer can also be isolated and recycled.

Any suitable oligomerization temperature, oligomerization reaction pressure, hydrogen partial pressure (if used), oligomerization reactor vessel (or vessels), catalyst system, catalyst deactivation technique, separation techniques (e.g., flashing, distillation, etc.), and hydrogenation process and catalyst can be utilized. These are exemplified in representative U.S. Pat. No. 8,536,391, 9,334,203, 9,745,230, 9,266,793, and 9,708,549.

### EXAMPLES

The invention is further illustrated by the following examples, which are not to be construed in any way as imposing limitations to the scope of this invention. Various other aspects, embodiments, modifications, and equivalents thereof which, after reading the description herein, may suggest themselves to one of ordinary skill in the art without departing from the spirit of the present invention or the scope of the appended claims.

Kinematic viscosities at 100° C. and 40° C. were determined using an Anton Paar Automatic Kinematic Viscometer SVM 3001 in accordance with ASTM D7042-04 (Stabinger viscometer method) at the respective temperatures, and the results are reported in centistokes (cSt). Pour point is a measurement of the temperature at which the sample will begin to flow under carefully controlled conditions. Pour point was determined using a CPP 5Gs Automated Cloud and Pour Point Analyzer in accordance with ASTM D5950 (automatic tilt method), and the results are reported in ° C. The flash point was determined using a PAC Herzog OptiFlash Cleveland Open Cup instrument in accordance with ASTM D92 (but with an electric ignition source instead of a gas flame), and the results are reported in ° C. Density was determined in accordance with ASTM D4052. A Flucon Thermal Conductivity meter was used to obtain the thermal conductivity in accordance with ASTM D7896-19.

Example 1 was a distilled C₈ dimer fraction isolated from a metallocene-catalyzed 1-octene oligomerization reaction product, which was then hydrogenated to form a C₁₆ alkane composition. Example 1 contained approximately 95-98 wt. % hydrogenated 1-octene dimers (and approximately 95-98 wt. % C₁₆ alkanes).

Example 2 was a distilled C₈ trimer fraction isolated from a metallocene-catalyzed 1-octene oligomerization reaction product, which was then hydrogenated to form a C₂₄ alkane composition. Example 2 contained approximately 95-98 wt. % hydrogenated 1-octene trimers (and approximately 95-98 wt. % C₂₄ alkanes).

Example 3 was a mixture of C₈ oligomers isolated from a metallocene-catalyzed 1-octene oligomerization reaction product, which was then hydrogenated to form a C₁₆-C₂₄ alkane composition (with some C₃₂ alkanes).

To fractionate samples of the metallocene-catalyzed 1-octene oligomerization reaction product, a BR Instrument D2892 Crude Oil Distillation System was utilized. The vacuum was set to 10 torr and the heater was set to 100% until 95° C., at which point the heater was reduced to 65%. The distillation was stopped after all of the light components had been distilled (approximately 1-2% of the total volume). A more intensive distillation was used to isolate the C₁₆ and C₂₄ fractions. In this case, the vacuum was set to 10 torr and the heater was set to 100% until 95° C., at which point the heater was reduced to 65%. The C₁₆ fraction was collected when the overhead temperature was in the 142-162° C. range. The C₂₄ fraction was collected when the overhead temperature was in the 215-235° C. range. GC analysis was used to confirm the clean fractionation of the samples.

Samples were hydrogenated in a Zipperclave reactor using 6 wt. % Johnson Matthey HTC Ni 500 hydrogenation catalyst at 900 psig H₂ and 200° C. for 6 hr. Full hydrogenation of the fractions was confirmed by testing the alkane composition sample by bromine index.

Comparative Example 4 (Example C4) was a nominal 2 cSt (KV100) PAO based on 1-decene dimers (PAO 2). Comparative Example 5 (Example C5) was a nominal 2.5 cSt (KV100) PAO based on 1-dodecene dimers (PAO 2.5). Comparative Example 6 (Example C6) is hexadecane (a C₁₆ alkane).

Properties of these examples are summarized in Table 1. Referring first to the C₁₆ alkane composition of Example 1, as compared to Example C4 (C₁₀ dimer, PAO 2), Example 1 beneficially has lower viscosity (KV100 and KV40) and a significantly lower density. As compared to Example C6 (hexadecane) with the same carbon number and comparable viscosity, Example 1 has a much lower pour point, thus indicating that the composition of Example 1 will remain in the liquid phase over a much wider temperature range than that of Example C6. With approximately 5 wt. % of either C₈ or C₂₄ in Example 1, typical values of KV100 (cSt) are 1.1-1.22, KV40 (cSt) are 2.6-3.0, density @15° C. (g/cc) are 0.776-0.779, pour point (° C.) are −42 to −47, and flash point (° C.) are 120-130.

Referring now to the C₂₄ alkane composition of Example 2, as compared to Example C5 (C₁₂ dimer, PAO 2.5), Example 2 has similar viscosity in combination with a beneficially lower density. Unexpectedly, Example 2 also has both a lower pour point and a higher flash point than that of Example C5, at the same carbon number, thus indicating that Example 2 will remain in the liquid phase over a much wider temperature range than that of Example C5. Also unexpectedly, Example 2 has both a lower pour point and a higher flash point than that of Example C4 (C₁₀ dimer, PAO 2). With approximately 5 wt. % of either C₁₆ or C₃₂ in Example 2, typical values of KV100 (cSt) are 2.35-2.55, KV40 (cSt) are 8.2-9.1, density @15° C. (g/cc) are 0.802-0.804, pour point (° C.) are −76 to −86, and flash point (° C.) are 188-198.

Referring now to the C₁₆-C₂₄ alkane composition of Example 3, as compared to Example C4 (C₁₀ dimer, PAO 2), Example 3 beneficially has lower viscosity (KV100 and KV40) and a significantly lower density. Depending upon the relevant amounts of dimer, trimer, and tetramer, the pour point and flash point of the alkane composition of Example 3 approach the values for Example C4 (C₁₀ dimer, PAO 2).

Table 2 summarizes the compositional breakdown of eighteen (18) different C₁₆-C₂₄ (and some C₃₂) olefin compositions (labeled A thru R), which were mixtures of C₈ oligomers isolated from a metallocene-catalyzed 1-octene oligomerization reaction product, but prior to hydrogenation (e.g., as in Example 3). For these 18 experiments, the dimer (C₁₆ olefin) content was in the 63-82 wt. % range, the trimer (C₂₄ olefin) content was in the 12-27 wt. % range, and the tetramer (C₃₂ olefin) content was in the 1-6 wt. % range. The dimers, trimers, and tetramers of these examples account for approximately 94-99 wt. % of the composition. Of the remainder, the majority is <C₁₄ hydrocarbons, including residual 1-octene (monomer) reactant. Depending upon the relative dimer (C₁₆ olefin) and trimer (C₂₄ olefin) content, the values of KV100, KV40, density, pour point, and flash point can effectively range from that of Example 1 to Example 2. The weight percentages in Table 2 were determined via gas chromatography with a mass detector, in particular, a 7890A/5979C GCMS equipped with a ZB-5HT Inferno 30 M×250μmX0, 10 μm column with a flow of 1 mL/min with a 10 min hold time at 35° C., then a ramp of 20° C./min to 380° C., and then a 3 min hold time.

TABLE 1
Properties of Examples 1-3 and Comparative Examples C4-C6.

| Property | Example 1 | Example 2 | Example 3 | C4 | C5 | C6 |
|---|---|---|---|---|---|---|
| General description | C₁₆ alkanes | C₂₄ alkanes | C₁₆-C₂₄ alkanes | C₁₀ dimer PAO | C₁₂ dimer PAQ | Hexadecane |
| KV100 (cSt) | 1.17 | 2.45 | 1.29 | 1.7 | 2.4 | 1.2 |
| KV40 (cSt) | 2.8 | 8.7 | 3.2 | 5.1 | 8.3 | 2.9 |
| Density @ 15° C. (g/cc) | 0.7775 | 0.8035 | 0.7805 | 0.7974 | 0.8064 | 0.77 |
| Pour point (° C.) | −44 | −83 | −69 | −73 | −52 | 18* |
| Flash point (° C.) | 128 | 196 | 140 | 158 | 180 | 137 |
| Noack Volatility | 64% | 8% | 40% | 15.8% | 6% | — |
| (at 200° C.) | | | | | | |
| Thermal Conductivity | 142 | 146 | 145 | 144 | 150 | — |
| (at 0° C., mW/m*K) | | | | | | |
| Specific Heat | 1972 | 1940 | 1975 | 1938 | 1981 | — |
| (at 0° C., J/kg*K) | | | | | | |

*Literature melting point

TABLE 2
Oligomer product content of the C₁₆-C₃₂ olefin compositions of Examples A-R.

| Component | A | B | C | D | E | F | G | H | I |
|---|---|---|---|---|---|---|---|---|---|
| 1-octene dimers - C₁₆ | 71.9 | 74.4 | 73.9 | 73.6 | 73.1 | 70.3 | 67.6 | 69.3 | 63.4 |
| 1-octene trimers - C₂₄ | 20.9 | 18.3 | 19.7 | 20.5 | 20.0 | 20.9 | 25.1 | 23.4 | 26.3 |
| 1-octone tetramers - C₃₂ | 3.7 | 3.8 | 3.0 | 4.1 | 3.7 | 4.6 | 5.6 | 4.8 | 6.5 |
| Component | J | K | L | M | N | O | P | Q | R |
| 1-octene dimers - C₁₆ | 78.5 | 75.6 | 81.1 | 80.2 | 73.1 | 73.8 | 69.8 | 74.8 | 79.4 |
| 1-octene trimers - C₂₄ | 16.7 | 17.8 | 12.3 | 13.3 | 21.5 | 21.7 | 25.3 | 21.2 | 17.6 |
| 1-octene tetramers - C₃₂ | 1.9 | 1.9 | 1.3 | 1.3 | 4.7 | 3.8 | 4.4 | 3.2 | 2.1 |

The invention is described above with reference to numerous aspects and embodiments, and specific examples. Many variations will suggest themselves to those skilled in the art in light of the above detailed description. All such obvious variations are within the full intended scope of the appended claims. Other aspects of the invention can include, but are not limited to, the following (aspects are described as “comprising” but alternatively, can “consist essentially of” or “consist of”):

Aspect 1. A non-pyrophoric composition comprising an alkane composition comprising C₁₆-C₃₆ alkanes, and a pyrophoric material.

Aspect 2. The non-pyrophoric composition defined in aspect 1, wherein the pyrophoric material comprises an organometallic (e.g., an alkyl aluminum, an alkyl lithium, an alkyl boron such as TEB) or a reactive metal (e.g., sodium, potassium).

Aspect 3. The non-pyrophoric composition defined in aspect 1 or 2, wherein an amount of the pyrophoric material in the non-pyrophoric composition is in a range from 0.1 to 65 wt. %, from 1 to 50 wt. %, from 1 to 10 wt. %, from 2 to 40 wt. %, from 2 to 15 wt. %, from 5 to 50 wt. %, from 5 to 35 wt. %, from 5 to 20 wt. %, from 10 to 65 wt. %, from 10 to 35 wt. %, or from 10 to 20 wt. %.

Aspect 4. The non-pyrophoric composition defined in any one of aspects 1-3, wherein the pyrophoric material comprises the organometallic.

Aspect 5. The non-pyrophoric composition defined in any one of aspects 1-3, wherein the pyrophoric material comprises the reactive metal.

Aspect 6. A battery temperature control system comprising (i) a battery assembly in direct contact with (and surrounded by) an alkane composition comprising C₁₆-C₃₆ alkanes, the alkane composition contained within an outer casing, (ii) an inlet for introducing the alkane composition to the battery assembly, and (iii) an outlet for discharging the alkane composition from the battery assembly.

Aspect 7. The system defined in aspect 6, wherein the system further comprises a recirculation device (e.g., a pump) for conveying the alkane composition to the inlet and for receiving the alkane composition from the outlet.

Aspect 8. The system defined in aspect 6 or 7, wherein the system further comprises a temperature sensor (one, two or more) for measuring a temperature of the battery assembly (or a temperature of the alkane composition in direct contact with the battery assembly, or a temperature of the alkane composition discharged through the outlet).

Aspect 9. The system defined in any one of aspects 6-8, wherein the system further comprises a controller configured to adjust a flow rate of the alkane composition through the inlet based on (or according to) a temperature of the battery assembly (or a temperature of the alkane composition at any suitable location in the system).

Aspect 10. The system defined in any one of aspects 6-9, wherein the system further comprises a cooling device (e.g., a radiator, a heat exchanger) configured to remove heat from the alkane composition discharged through the outlet, the cooling device positioned between the outlet and the recirculation device.

Aspect 11. A battery system comprising (I) an internal battery assembly, (II) a separator film encapsulating the internal battery assembly, (III) an outer shell (or casing) surrounding the separator film and the internal battery assembly, and (IV) a liquid layer comprising an alkane composition comprising C₁₆-C₃₆ alkanes, the liquid layer positioned between the outer shell and the separator film.

Aspect 12. The composition or system defined in any one of aspects 1-11, wherein the alkane composition comprises at least 90 wt. % (or least 92 wt. %, at least 95 wt. %, at least 97 wt. %, at least 98 wt. %, or at least 99 wt. %) C₁₆ alkanes (hydrogenated 1-octene dimers) and is characterized by a KV100 in a range from 0.9 to 1.5 cSt, a KV40 in a range from 2 to 3.6 cSt, and a flash point in a range from 115 to 140° C. and/or a pour point in a range from −60 to −30° C.

Aspect 13. The composition or system defined in aspect 12, wherein the KV100 (100° C. kinematic viscosity) is in any range disclosed herein, e.g., from 1 to 1.5 cSt, from 1 to 1.4 cSt, from 1 to 1.3 cSt, from 1.1 to 1.5 cSt, from 1.1 to 1.4 cSt, or from 1.1 to 1.3 cSt.

Aspect 14. The composition or system defined in aspect 12 or 13, wherein the KV40 (40° C. kinematic viscosity) is in any range disclosed herein, e.g., from 2 to 3.4 cSt, from 2.2 to 3.6 cSt, from 2.2 to 3.4 cSt, from 2.4 to 3.4 cSt, from 2.4 to 3.2 cSt, from 2.4 to 3 cSt, from 2.6 to 3.2 cSt, from 2.6 to 3 cSt, or from 2.7 to 2.9 cSt.

Aspect 15. The composition or system defined in any one of aspects 12-14, wherein the flash point is in any range disclosed herein, e.g., from 115 to 135° C., from 115 to 130° C., from 120 to 140° C., from 120 to 135° C., from 120 to 130° C., from 125 to 135° C., or from 125 to 130° C.

Aspect 16. The composition or system defined in any one of aspects 12-15, wherein the pour point is in any range disclosed herein, e.g., from −60 to −35° C., from −60 to −40° C., from −55 to −30° C., from −55 to −35° C., from −55 to −40° C., from −50 to −30° C., from −50 to −35° C., or from −50 to −40° C.

Aspect 17. The composition or system defined in any one of aspects 12-16, wherein the alkane composition is further characterized by a density at 15° C. in any range disclosed herein, e.g., from 0.773 to 0.782 g/cc, from 0.774 to 0.781 g/cc, from 0.775 to 0.780 g/cc, from 0.776 to 0.779 g/cc, from 0.776 to 0.778 g/cc, from 0.777 to 0.779 g/cc, or from 0.777 to 0.778 g/cc.

Aspect 18. The composition or system defined in any one of aspects 1-11, wherein the alkane composition comprises at least 90 wt. % (or least 92 wt. %, at least 95 wt. %, at least 97 wt. %, at least 98 wt. %, or at least 99 wt. %) C₂₄ alkanes (hydrogenated 1-octene trimers) and is characterized by a KV100 in a range from 2 to 3 cSt, a KV40 in a range from 7.7 to 9.7 cSt, and a flash point in a range from 185 to 215° C. and/or a pour point in a range from −95 to −70° C.

Aspect 19. The composition or system defined in aspect 18, wherein the KV100 (100° C. kinematic viscosity) is in any range disclosed herein, e.g., from 2.1 to 2.9 cSt, from 2.2 to 2.8 cSt, from 2.3 to 2.7 cSt, from 2.3 to 2.6 cSt, from 2.3 to 2.5 cSt, from 2.4 to 2.7 cSt, from 2.4 to 2.6 cSt, or from 2.4 to 2.5 cSt.

Aspect 20. The composition or system defined in aspect 18 or 19, wherein the KV40 (40° C. kinematic viscosity) is in any range disclosed herein, e.g., from 7.8 to 9.6 cSt, from 7.9 to 9.5 cSt, from 8 to 9.4 cSt, from 8.1 to 9.3 cSt, from 8.2 to 9.2 cSt, from 8.3 to 9.1 cSt, from 8.4 to 9 cSt, from 8.5 to 8.9 cSt, or from 8.6 to 8.8 cSt.

Aspect 21. The composition or system defined in any one of aspects 18-20, wherein the flash point is in any range disclosed herein, e.g., from 185 to 205° C., from 185 to 200° C., from 188 to 202° C., from 190 to 215° C., from 190 to 205° C., from 192 to 200° C., or from 194 to 198° C.

Aspect 22. The composition or system defined in any one of aspects 18-21, wherein the pour point is in any range disclosed herein, e.g., from −90 to −70° C., from −90 to −75° C., from −88 to −75° C., from −88 to −78° C., or from −85 to −80° C.

Aspect 23. The composition or system defined in any one of aspects 18-22, wherein the alkane composition is further characterized by a density at 15° C. in any range disclosed herein, e.g., from 0.799 to 0.808 g/cc, from 0.800 to 0.807 g/cc, from 0.801 to 0.806 g/cc, from 0.802 to 0.805 g/cc, from 0.802 to 0.804 g/cc, from 0.803 to 0.805 g/cc, or from 0.803 to 0.804 g/cc.

Aspect 24. The composition or system defined in any one of aspects 1-11, wherein the alkane composition comprises (a) from 5 to 95 wt. % C₁₆ alkanes (hydrogenated 1-octene dimers), and (b) from 95 to 5 wt. % C₂₄ alkanes (hydrogenated 1-octene trimers), based on a total weight of the C₁₆ alkanes and the C₂₄ alkanes.

Aspect 25. The composition or system defined in aspect 24, wherein the alkane composition comprises any amount of the C₁₆ alkanes disclosed herein, e.g., from 10 to 90 wt. %, from 50 to 90 wt. %, from 15 to 85 wt. %, from 50 to 85 wt. %, from 25 to 75 wt. %, or from 35 to 65 wt. %, of the C₁₆ alkanes, based on a total weight of the C₁₆ alkanes and the C₂₄ alkanes.

Aspect 26. The composition or system defined in aspect 24 or 25, wherein the alkane composition comprises (a) from 40 to 90 wt. %, from 50 to 85 wt. %, from 55 to 95 wt. %, or from 58 to 80 wt. % of the C₁₆ alkanes (hydrogenated 1-octene dimers), and (b) from 10 to 60 wt. %, from 10 to 50 wt. %, from 10 to 30 wt. %, or from 14 to 30 wt. % of the C₂₄ alkanes (hydrogenated 1-octene trimers), based on a total weight of the composition.

Aspect 27. The composition or system defined in any one of aspects 24-26, wherein the alkane composition further comprises (c) from 0.5 to 20 wt. %, from 1 to 12 wt. %, from 1 to 9 wt. %, or from 2 to 8 wt. % C₃₂ alkanes (hydrogenated 1-octene tetramers), based on a total weight of the composition.

Aspect 28. The composition or system defined in any one of aspects 24-27, wherein the alkane composition has a KV100 (100° C. kinematic viscosity) in any range disclosed herein, e.g., from 1 to 2.9 cSt, from 1 to 2.5 cSt, from 1 to 2 cSt, from 1 to 1.6 cSt, from 1.1 to 2.5 cSt, from 1.1 to 2 cSt, from 1.1 to 1.6 cSt, from 1.2 to 2.5 cSt, from 1.2 to 2 cSt, from 1.3 to 2.9 cSt, or from 1.3 to 2.5 cSt.

Aspect 29. The composition or system defined in any one of aspects 24-28, wherein the alkane composition has a KV40 (40° C. kinematic viscosity) in any range disclosed herein, e.g., from 2 to 9.5 cSt, from 2 to 8.5 cSt, from 2.5 to 8.5 cSt, from 2.5 to 7 cSt, from 2.5 to 5 cSt, from 2.5 to 4 cSt, from 3 to 8 cSt, from 3 to 6 cSt, from 4 to 9 cSt, or from 4 to 6 cSt.

Aspect 30. The composition or system defined in any one of aspects 24-29, wherein the alkane composition has a flash point in any range disclosed herein, e.g., from 100 to 200° C., from 100 to 150° C., from 120 to 180° C., from 120 to 160° C., from 130 to 190° C., from 130 to 160° C., or from 140 to 180° C.

Aspect 31. The composition or system defined in any one of aspects 24-30, wherein the alkane composition has a pour point in any range disclosed herein, e.g., from −85 to −35° C., from −80 to −40° C., from −75 to −40° C., from −75 to −45° C., or from −70 to −45° C.

Aspect 32. The composition or system defined in any one of aspects 24-31, wherein the alkane composition has a density at 15° C. in any range disclosed herein, e.g., from 0.776 to 0.805 g/cc, from 0.778 to 0.803 g/cc, from 0.778 to 0.790 g/cc, from 0.780 to 0.803 g/cc, from 0.780 to 0.800 g/cc, from 0.780 to 0.795 g/cc, or from 0.780 to 0.790 g/cc.

Aspect 33. The composition or system defined in any one of aspects 1-32, wherein the alkane composition further comprises an additive (one additive, two or more additives) selected from an anti-wear additive, a dispersant, a viscosity modifier, a friction modifier/reducer, a detergent, a demulsifier, a defoamant, an antioxidant, an extreme pressure agent, a rust/corrosion inhibitor, a metal passivator, a pour point depressant, a thickener, or any combination thereof.

Aspect 34. A method of controlling or moderating battery temperature, the method comprising introducing an alkane composition into an inlet of a battery temperature control system, the battery temperature control system comprising an outer casing encompassing the alkane composition and a battery assembly, wherein the alkane composition comprises C₁₆-C₃₆ alkanes, directly contacting the alkane composition with the battery assembly to regulate a temperature of the battery assembly, and discharging the alkane composition from the battery assembly through an outlet of the battery temperature control system.

Aspect 35. The method defined in aspect 34, wherein the contacting the alkane composition with the battery assembly passivates reactive chemistry within the battery assembly.

Aspect 36. The method defined in aspect 34 or 35, further comprising recirculating the alkane composition through the inlet and the outlet of the battery temperature control system.

Aspect 37. The method defined in aspect 34 or 35, further comprising receiving the alkane composition from the outlet and conveying the alkane composition to the inlet via a recirculation device.

Aspect 38. The method defined in any one of aspects 34-37, further comprising removing heat, via a cooling device, from the alkane composition discharged through the outlet.

Aspect 39. The method defined in aspect 38, wherein the cooling device is positioned between the outlet and the recirculation device.

Aspect 40. The method defined in any one of aspects 34-39, further comprising adjusting a flow rate of the alkane composition through the inlet according to the temperature of the battery assembly, or a temperature of the alkane composition at any suitable location in the system.

Aspect 41. The method defined in any one of aspects 34-40, further comprising measuring, via one or more temperature sensors, a temperature of the battery assembly, or of the alkane composition in direct contact with the battery assembly, or of the alkane composition discharged through the outlet.

Aspect 42. The method defined in aspect 41, further comprising providing information or data from the one or more temperature sensors to a controller.

Aspect 43. The method defined in aspect 42, further comprising controlling or moderating the temperature of the battery assembly according to the adjusted flow rate via the controller.

Aspect 44. A method of temperature control of a battery system, the method comprising: providing a battery system comprising an internal battery assembly a separator film encapsulating the internal battery assembly and an outer shell surrounding the separator film and the internal battery assembly, and positioning a liquid layer between the outer shell and the separator film to regulate temperature, wherein the liquid layer comprises an alkane composition comprising C₁₆-C₃₆ alkanes.

Aspect 45. The method defined in aspect 44, wherein the liquid layer passivates reactive chemistry within the internal battery assembly.

Aspect 46. The method defined in aspect 44 or 45, further comprising removing heat generated from charging or discharging the internal battery assembly.

Aspect 47. The method defined in any one of aspects 44-46, wherein the liquid layer absorbs heat generated by the internal battery assembly.

Aspect 48. The method defined in any one of aspects 44-47, wherein the liquid layer acts as a cooling medium for heat generated from charging or discharging the internal battery assembly.

Aspect 49. The method defined in any one of aspects 44-48, wherein the liquid layer slows or inhibits reactivity of components of the internal battery assembly.

Aspect 50. The method defined in any one of aspects 44-49, wherein the internal battery assembly comprises a battery cell.

Aspect 51. The method defined in any one of aspects 44-50, wherein the internal battery assembly comprises lithium or other pyrophoric reagents.

Aspect 52. The method defined in any one of aspects 34-51, wherein the alkane composition is further characterized by any one of aspects 12-33.

We claim:

1. A battery temperature control system comprising:
(i) a battery assembly in direct contact with an alkane composition comprising C₁₆-C₃₆ alkanes, the alkane composition contained within an outer casing;
(ii) an inlet for introducing the alkane composition to the battery assembly; and
(iii) an outlet for discharging the alkane composition from the battery assembly.

2. The system of claim 1, wherein the system further comprises a recirculation device for conveying the alkane composition to the inlet and for receiving the alkane composition from the outlet.

3. The system of claim 1, wherein the system further comprises a temperature sensor for measuring a temperature of the battery assembly, or of the alkane composition in direct contact with the battery assembly, or of the alkane composition discharged through the outlet.

4. The system of claim 1, wherein the system further comprises a controller configured to adjust a flow rate of the alkane composition through the inlet based on a temperature of the battery assembly, or of the alkane composition at any suitable location in the system.

5. The system of claim 1, wherein the system further comprises a cooling device configured to remove heat from the alkane composition discharged through the outlet, the cooling device positioned between the outlet and the recirculation device.

6. The system of claim 1, wherein the alkane composition comprises:
(a) from 5 to 95 wt. % C₁₆ alkanes (hydrogenated 1-octene dimers); and
(b) from 95 to 5 wt. % C₂₄ alkanes (hydrogenated 1-octene trimers); based on a total weight of the C₁₆ alkanes and the C₂₄ alkanes.

7. The system of claim 6, wherein the alkane composition comprises from 10 to 90 wt. % of the C₁₆ alkanes, based on the total weight of the C₁₆ alkanes and the C₂₄ alkanes.

8. The system of claim 6, wherein the alkane composition comprises:
(a) from 40 to 90 wt. % of the C₁₆ alkanes (hydrogenated 1-octene dimers); and
(b) from 10 to 60 wt. % of the C₂₄ alkanes (hydrogenated 1-octene trimers); based on a total weight of the composition.

9. The system of claim 8, wherein the alkane composition further comprises (c) from 0.5 to 20 wt. % C₃₂ alkanes (hydrogenated 1-octene tetramers), based on the total weight of the composition.

10. The system of claim 6, wherein the alkane composition has:
a KV100 (100° C. kinematic viscosity) in a range from 1 to 2.9 cSt;
a KV40 (40° C. kinematic viscosity) in a range from 2 to 9.5 cSt;
a flash point in a range from 100 to 200° C.;
a pour point in a range from −85 to −35° C.;
a density at 15° C. in a range from 0.776 to 0.805 g/cc; or
any combination thereof.

11. The system of claim 1, wherein the alkane composition comprises at least 90 wt. % C₂₄ alkanes (hydrogenated 1-octene trimers) and is characterized by:
a KV100 in a range from 2 to 3 cSt;
a KV40 in a range from 7.7 to 9.7 cSt; and
a flash point in a range from 185 to 215° C. and/or a pour point in a range from −95 to −70° C.

12. The system of claim 1, wherein the alkane composition comprises at least 90 wt. % C₁₆ alkanes (hydrogenated 1-octene dimers) and is characterized by:
a KV100 in a range from 0.9 to 1.5 cSt;
a KV40 in a range from 2 to 3.6 cSt; and
a flash point in a range from 115 to 140° C. and/or a pour point in a range from −60 to −30° C.

13. The system of claim 1, wherein the alkane composition further comprises an additive selected from an anti-wear additive, a dispersant, a viscosity modifier, a friction modifier/reducer, a detergent, a demulsifier, a defoamant, an antioxidant, an extreme pressure agent, a rust/corrosion inhibitor, a metal passivator, a pour point depressant, a thickener, or any combination thereof.

14. A battery system comprising:
(I) an internal battery assembly;
(II) a separator film encapsulating the internal battery assembly;
(III) an outer shell surrounding the separator film and the internal battery assembly; and
(IV) a liquid layer comprising an alkane composition comprising C₁₆-C₃₆ alkanes, the liquid layer positioned between the outer shell and the separator film.

15. The system of claim 14, wherein the alkane composition comprises:
(i) at least 90 wt. % C₂₄ alkanes (hydrogenated 1-octene trimers) characterized by a KV100 in a range from 2 to 3 cSt; a KV40 in a range from 7.7 to 9.7 cSt; and a flash point in a range from 185 to 215° C. and/or a pour point in a range from −95 to −70° C.;
(ii) at least 90 wt. % C₁₆ alkanes (hydrogenated 1-octene dimers) characterized by a KV100 in a range from 0.9 to 1.5 cSt; a KV40 in a range from 2 to 3.6 cSt; and a flash point in a range from 115 to 140° C. and/or a pour point in a range from −60 to −30° C.; or
(iii) from 5 to 95 wt. % C₁₆ alkanes (hydrogenated 1-octene dimers) and from 95 to 5 wt. % C₂₄ alkanes (hydrogenated 1-octene trimers), based on a total weight of the C₁₆ alkanes and the C₂₄ alkanes.

16. A composition comprising:
an alkane composition comprising C₁₆-C₃₆ alkanes; and
a pyrophoric material.

17. The composition of claim 16, wherein the pyrophoric material comprises an organometallic or a reactive metal.

18. The composition of claim 17, wherein the pyrophoric material comprises the organometallic.

19. The composition of claim 17, wherein the pyrophoric material comprises the reactive metal.

20. The composition of claim 17, wherein an amount of the pyrophoric material in the composition is in a range from 0.1 to 65 wt. %.

21. A method of controlling or moderating battery temperature, the method comprising:
(a) introducing an alkane composition into an inlet of a battery temperature control system, the battery temperature control system comprising an outer casing encompassing the alkane composition and a battery assembly, wherein the alkane composition comprises C₁₆-C₃₆ alkanes;
(b) directly contacting the alkane composition with the battery assembly to regulate a temperature of the battery assembly; and
(c) discharging the alkane composition from the battery assembly through an outlet of the battery temperature control system.
